(19) United States
(12) Patent Application Publication
(10) Pub. No.: US 2009/0000167 A1
(43) Pub. Date: Jan. 1, 2009

(54) Banner for eyeglasses

(76) Inventor: Paul Leonhardt, La Jolla, CA (US)

Correspondence Address: GRIMES & BATTERSBY, LLP, 488 MAIN AVENUE, THIRD FLOOR, NORWALK, CT, 06851, US

(21) Appl. No.: 12/214,495

(22) Filed: Jun. 19, 2008

Related U.S. Application Data
(60) Provisional application No. 60/936,244, filed on Jun. 19, 2007.

(51) Int. Cl. G09F 21/02

(52) U.S. Cl. 40/586

(57) ABSTRACT

The invention consists of a pair of triangular components of a flexible material that attach to the arms of a pair of eyeglasses or sunglasses. The material may be printed for promotional or advertising purposes. Each triangular component or banner includes means for easily and removably attaching the banner to the arms of the glasses.

### CROSS REFERENCES TO RELATED APPLICATIONS

This application claims priority benefit of a U.S. Provisional Application, Ser. No. 60/936,244, filed in the United States Patent and Trademark Office on Jun. 19, 2007, and entitled “Banner for glasses” by Paul Leonhardt, the same inventor herein.

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to a promotional or advertising product, and more particularly to a promotional or advertising device that is worn with a pair of eyeglasses or sunglasses.

B. Brief Description of the Prior Art

Ornamental devices that attach to eyeglasses have long been known, as have side-blinder-type devices that attach to the arms of eyeglasses and sunglasses. Examples of the former are shown in U.S. Design Pat. No. Des. 425,544, which issued to Erpillo on May 23, 2000 for “Decorative clip for eyeglasses”; U.S. Pat. No. 4,968,128, which issued to Mendola on Nov. 6, 1990 for “Eyeglass frame ornamentation”; U.S. Pat. No. 5,497,211, which issued to McNulty on Mar. 5, 1996 for “Indicia display device for eyeglasses or the like”; and U.S. Pat. No. 5,764,338, which issued to Mack on Jun. 9, 1998 for “Holder for a mask or the like.” Examples of the latter are shown in U.S. Design Pat. No. Des. 374,451, which issued to Gurwin on Oct. 8, 1996 for “Eyeglasses with side blinders” and U.S. Pat. No. 4,298,991, which issued on Nov. 1, 1981 to Recenello for “Peripheral view blinders”

### BRIEF SUMMARY OF THE INVENTION

It is an object of the present invention to provide a promotional or advertising device that may be worn with eyeglasses or sunglasses.

It is another object of the present invention to provide such a promotional or advertising device that may be easily attached to the arms of a pair of glasses.

It is yet another object of the present invention to provide such a promotional or advertising device that may be easily removed from the arms of a pair of glasses.

It is still another object of the present invention to provide such a promotional or advertising device that also serves to block out unwanted light, sunlight, glare and/or debris from either side of the viewer's head.

The present invention, in brief summary, comprises triangular components of a flexible material that attach to the arms of a pair of eyeglasses or sunglasses. The material may be printed for promotional or advertising purposes. Each triangular component or banner includes means for easily and removably attaching the banner to the arms of the glasses.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a side view showing the banner for glasses of the present invention being worn with a pair of sunglasses;

FIG. 2 is a right side perspective view showing the banner for glasses of the present invention attached to a pair of sunglasses;

FIG. 3 is a left side perspective view showing the banner for glasses of the present invention attached to a pair of sunglasses;

FIG. 4 is an isometric view showing a pair of the banners for glasses of the present invention;

FIG. 5 is a left side view of the banner invention on a pair of eyeglasses;

FIG. 6 is a left side view of the banner invention on a pair of eyeglasses;

FIG. 7 is a side view of a first banner embodiment;

FIG. 8 is side view of a second banner embodiment;

FIG. 9 is side view of a third banner embodiment;

FIG. 10 is side view of a fourth banner embodiment;

FIG. 11 is side view of a fifth banner embodiment;

FIG. 12 is an end view of FIG. 11;

FIG. 13 is an end view of FIG. 11;

FIG. 14 is three quarter perspective view of a sixth banner embodiment;

FIG. 15 is an end view of FIG. 14; and

FIG. 16 is an end view of FIG. 14.

### DETAILED DESCRIPTION OF THE EMBODIMENT

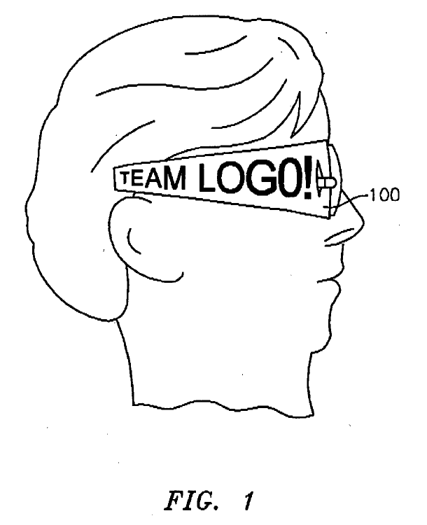

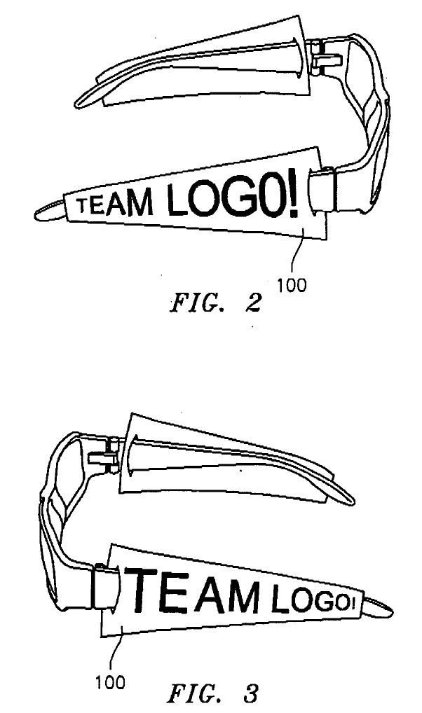

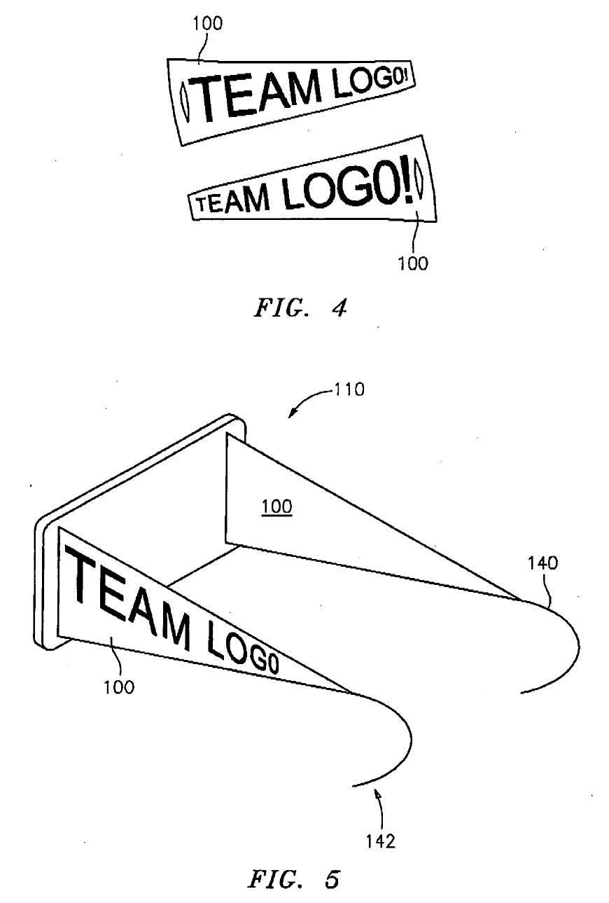

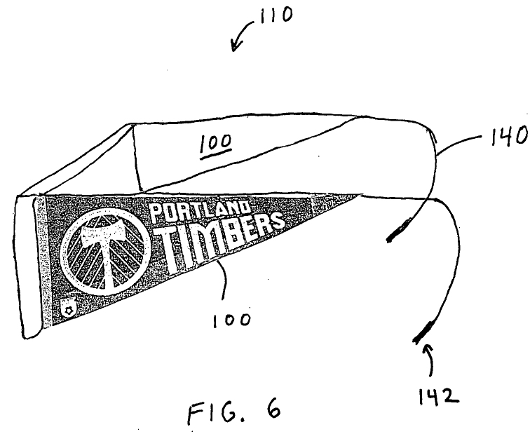

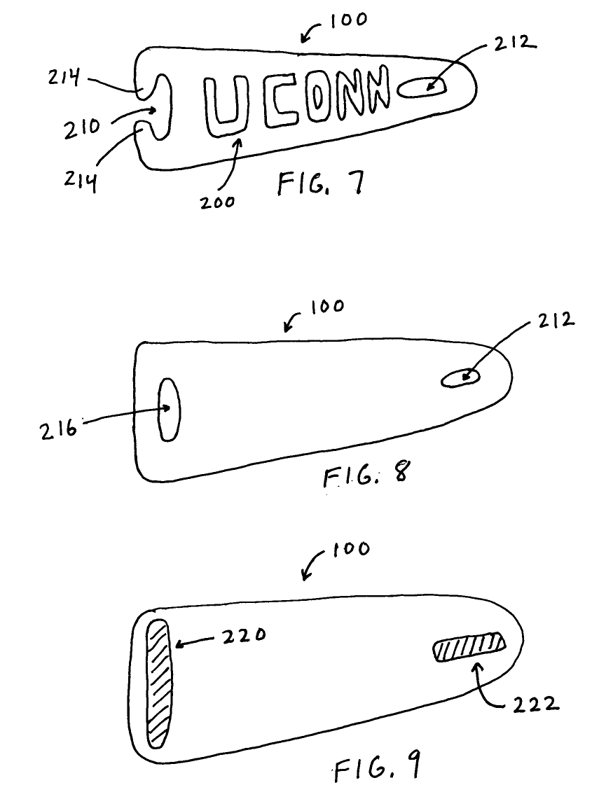

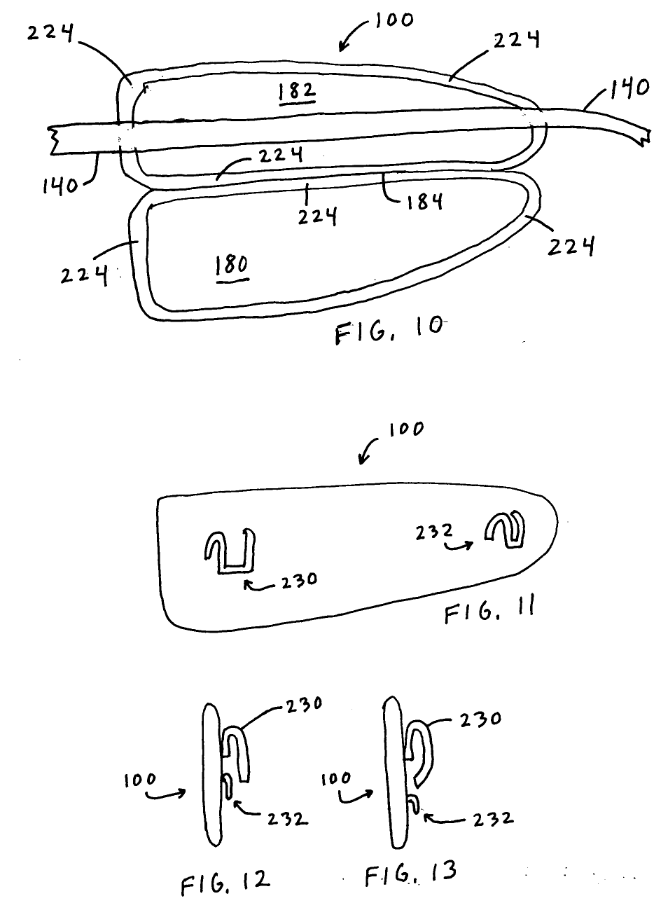

Referring now to FIGS. 1-4 of the drawings, a preferred embodiment of a banner for glasses is illustrated and is referred to generally by reference number 10. The device comprises a pair of banner components 100 composed preferably of a flexible material. Examples of such material include paper or plastic, although other materials could work equally effective, provided they do not interfere with or damage the glasses 110 or more importantly create a safety or health hazard to the wearer or persons around or near the wearer. That is why thin metal plates would not be a preferred material for banners 100.

Imprinted or otherwise provide on the exterior surface 120 of the banner components 100 are indicia 130. In the preferred embodiment, indicia 130 comprise advertising or promotional graphics or text, such as a team name or a product. Of course, any graphical or textual material may be used for the indicia 130. The wearer may even create his own art for banners in several embodiments. It should also be appreciated that the indicia 130 is not required to be two-dimensional; three dimensional elements may be provided on the banner components 100.

In the preferred embodiment, the banner components 100 are triangular or trapezoidal in shape so as to simulate an actual banner or pennant. However, any shape that can be mounted to the arms 140 of the glasses 110 would be equally effective, provided of course there is sufficient surface area upon which the indicia 130 may be imprinted or displayed.

Provided on the banner components 100 are attachment means 150 for attaching the banner components 100 to the arms/temples 140 of the glasses 110. In the preferred embodiment, the attachment means comprise slits 160 in the banner components 100 through which the arms 140 may be slidably engaged. Other attachment means 150 include clips, elastics or even a temporary adhesive. The primary concern is that the attachment means 150 do not interfere with the operation of the glasses 110 or otherwise damage the glasses 110.

Referring now to FIG. 5 a pair of glasses 110 is shown with the banners 100 attached to the arms or temples 140. A banner 100 is also shown mounted on the temple distal to the viewer with a plain side or no logo visible as it is the inside of the banner and will rest against the wearer's head. However it should be noted that in another embodiment, logos are intentionally printed on both sides of the banner 100 so that the logo is much more visible when the glasses are not being worn, for example when they are laying on a kitchen counter or an automobile dashboard. The banner 100 in this particular embodiment displays the pennant of the Notre Dame football team, also known as the “Fighting Irish”. These banners 100 enhance the functionality of the glasses by providing more protection from unwanted sunlight and glare entering into the viewing space of the wearer from the side of the glasses.

Referring now to FIG. 6 a similar view as FIG. 5 is shown with the only difference being that the logo for the Portland Timbers soccer team.

Referring now to FIG. 7 a side view of a banner 100 is shown displaying the logo 200 “UCONN” of the University of Connecticut. A front notch 210 has been cut into the banner 100 to receive and attach to the front portion of a temple 140. The banner 100 is made of flexible material and the two fingers 214 are designed to flex and snap over the temples 140 as the fingers 214 will easily bend to secure the front portion of the banner 100 to the temples 140. The rear of the banner 100 is held in place by sliding the temple through a rear slot 212 so that the temple 140 remains on the non-logo or inside of the banner 100 and does not obstruct the logo 200.

Referring now to FIG. 8 a banner 100 is shown having a front slot 216 for receiving the temple 140. In this manner the entire temple 140 is secured by sliding the temple ends 142 (see FIGS. 5 & 6) first through the front slot 216 and then through the rear slot 212, taking care to thread the temple onto the non-logo side of the banner 100. In this manner the banner 100 is more secure than the banner in FIG. 7 as any accidental bumping or catching of the banner 100 on an edge will not as easily knock it off the glasses 110 of the wearer.

Referring now to FIG. 9 an adhesive version of the banner 100 is shown. A front adhesive strip 220 and a rear adhesive strip 222 are manufactured as part of the banner 100 and are placed on the non-logo or inside surface. The banners 100 are easily and removably attached to a pair of temples by simply applying them in the desired place and location with manual pressure. The adhesive is designed to be reused several times so that the wearer may use them on many different occasions. The adhesive also allows for the banners 100 to be attached to a wide variety of shapes and sizes of temples 140.

Referring now to FIG. 10 a folding banner 100 is shown. This banner 100 has an inside panel 180 and an outside panel 182 foldably attached by a flexible hinge 184. Each panel 182, 184 has a perimeter adhesive strip 224 attached to it's inside surface. Once the banner 100 is placed on the temple 140, it is then folded about the hinge 184 and the adhesive strips 224 on each panel of the banner 100 mate in a mirror image manner and secure the banner 100 to the temple 140.

Referring now to FIG. 11 is a side view of the interior side (wearer's head side) of a banner 100 which uses snaps or hooks 230, 232 for attachment means. The hooks 230, 232 are made of any elastically deformable material such as metal or plastic. The banner 100 is place in the desired location adjacent to the temple 140 and snapped into place.

Referring now to FIGS. 12 & 13 an end view of the banner 100 is shown displaying various shaped hooks 230, 232.

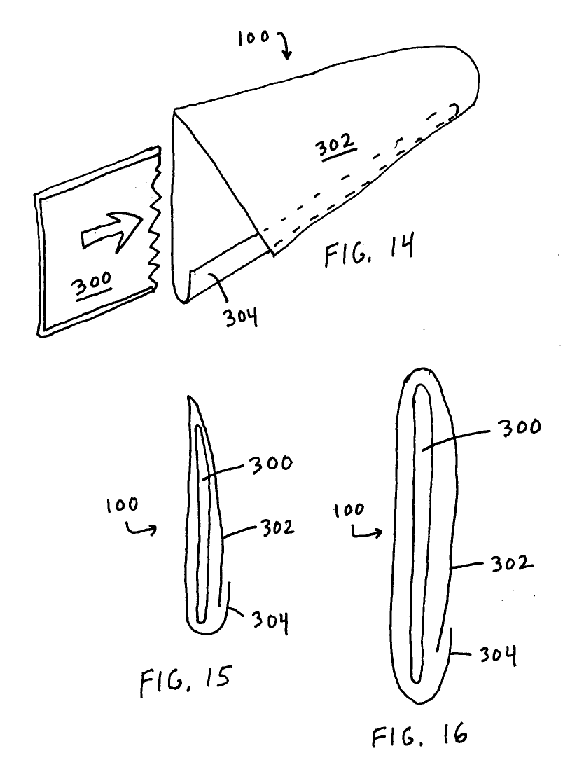

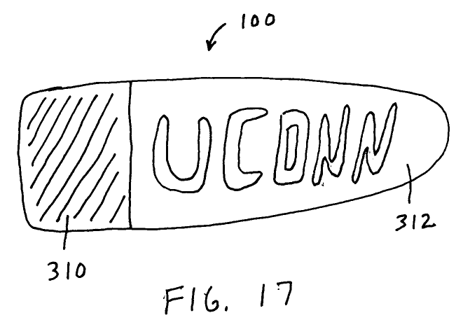

Referring now to FIGS. 14-16 another embodiment of the banner invention is shown. In this embodiment the banner 100 is made from clear transparent plastic and will receive an insert logo 300 of the wearer's choosing. As can be seen in FIG. 14, the logo 300 is being slide into the clear banner 100. The banner 100 may be designed in a sleeve manner so as to receive the logo 300 slidably from one end or the banner 100 may be designed as an envelope with a flap 302 which is secured by a lip 304 as is known in the art of plastic enclosures. FIGS. 14-16 display both the sleeve entrance and envelope entrance means. The transparent banner 100 may be manufactured in either one or a combination of these configurations.

Referring now to FIG. 17 another embodiment of the banner 100 is shown. In this embodiment the banner 100 is divided into two portions, a front panel 310 and a rear panel 312. Front panel 310 is made from transparent material to enhance the peripheral vision and safety of the wearer. The front panel 310 may have UV and sunglass protection qualities so as to filter out any unwanted sunlight or glare. The panel may even be polarized to filter out certain glare. This panel can also be clear in a safety glass environment. The rear panel 312 is for use as envisioned in other embodiments in that logos or advertising may be placed here. This embodiment may be mixed with other embodiments above such as the sleeve or envelope embodiments.

Having thus described the invention with particular reference to the preferred forms thereof, it will be obvious that various changes and modifications can be made therein without departing from the spirit and scope of the present invention as defined by the appended claims.

The inventor claims:

1. A banner for glasses of the type having a pair of arms for attachment to a user's ear, said banner comprising pair of banner components each including attachment means for removably attaching said banner components to said arms.

2. The banner for glasses of claim 1, wherein said banner components are composed of a flexible material.

3. The banner for glasses of claim 1, wherein said banner components are triangular in shape.

4. The banner for glasses of claim 1, upon which graphical indicia are provided on said banner components.

5. The banner for glasses of claim 1, wherein said attachment means comprises a pair of slits provided in each of said banner components through which said arms may be slidably engaged.

6. A banner enclosure made from a clear transparent material comprising:
a sleeve-like structure for receiving a logo insert;
attachment means for attaching the clear banner to a temple on a pair of glasses.

7. A banner enclosure for attaching to the temples of a pair of eyeglasses comprising:
an inner panel;
a mirror image outer panel foldably attached to said inner panel by a flexible hinge;
each said panel having an adhesive perimeter on their respective interior panel perimeters;
whereby when said panels are foldably mated about an eyeglass temple, their respective adhesive perimeters mate in a secure manner thus fixing said banner to the temples of the eyeglasses.
